(19) United States
(12) Patent Application Publication
(10) Pub. No.: US 2008/0312057 A1
(43) Pub. Date: Dec. 18, 2008

(54) POLYMER BAG

(75) Inventors: Sellakanthan Sakthiakumaran, Moorabbin (AU); Christopher David King, Moorabbin (AU)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Amcor Limited

(21) Appl. No.: 12/116,752

(22) Filed: May 7, 2008

(30) Foreign Application Priority Data
May 7, 2007 (AU) 2007902413

(51) Int. Cl. B31B 1/64

(52) U.S. Cl. 493/199

(57) ABSTRACT

A method of manufacturing a bag from a polymer film is disclosed. The method comprises (a) forming a bag with a front wall, a back wall, a bottom wall, opposed sides defined by heat seals of the front and back walls, skirts extending outwardly from the heat seals and an opening allowing access to the interior of the bag, and (b) piercing the bag and forming micro-perforations to achieve MAP functionality using piercing methods that are selected to reduce the stiction of the film in the front and back walls significantly below the tear strength of the film in the film orientation direction.

### BACKGROUND OF THE INVENTION

The present invention relates to polymer bags (which term includes bags described as “liners”) used to store products such as fresh fruit and vegetables.

In particular, the present invention relates to bags that are used to store products in the form of fresh fruit and vegetables within rigid bulk containers that support the bags, for example rigid containers made from cardboard, corrugated board, metals, rigid plastics, timber and other materials. The rigid containers typically have a rectangular footprint and vertical sides, and hence the bags are required to form a shape with a rectangular footprint and vertical sides once placed inside the rigid containers.

In particular, the present invention relates to a polymeric liner that can be sealed to form an airtight bag which is used to retain a modified atmosphere within the bag. Such bags are known in the art as “Modified Atmosphere Packaging”, or “MAP”. As an example, if the oxygen level is reduced and the carbon dioxide level is elevated in a bag compared to the oxygen and carbon dioxide levels in air, this will suppress respiration rate of fresh fruit or vegetables in the bag, which in turn will increase the shelf life of the produce before it loses product quality. Increasing the humidity level within a polymer liner bag can also help to increase the shelf life of the produce by slowing desiccation, and can be done independently of changing the oxygen or carbon dioxide levels in the bag.

The use of MAP allows for transportation of fresh fruit and vegetables over long distances from growing regions to intended markets. It also enhances the ability of retailers to have extended marketing seasons for perishable fruit and vegetables. As an example, fresh cherries packaged in an appropriate liner can be stored and marketed for 8 weeks from harvest compared to 2 weeks in traditional packaging.

The bags are typically made from films of polymers such as polyethylene (PE), low density polyethylene (LDPE), linear low density polyethylene (LLDPE), polypropylene (PP) or nylon (PA). Other suitable polymers can be used. Polymers with the desired transmission of moisture, oxygen and carbon dioxide for particular applications are rare and expensive or unavailable. It is desirable to manufacture liners for MAP from commodity polymers, and further to limit the range of polymer films used for the manufacture of MAP liners.

The desired process of selection of a MAP liner is to select a polymer with a desired intrinsic resistance to moisture transmission. Where a polymer that is selected on the basis of moisture transmission properties has insufficient transmission of oxygen and carbon dioxide, the transmission of oxygen and carbon dioxide can be increased by forming micro-perforations in the MAP liner. It is known that micro-perforations in a MAP liner have minimal effect on total moisture transmission.

Micro-perforations are commonly added to MAP liners by piercing the liners using needles that are heated to 250°-350° C. and are around 300 to 500 um in diameter, thereby producing holes of about this diameter. The liners are typically manufactured and then flattened in a folded form before being pierced with hot needles so that the needles pierce at least two layers of film (and sometimes 4 layers if the liner has been folded to include a gusset).

The polymer films used to fabricate the bags are typically manufactured by either blown or cast extrusion methods.

In the blown film extrusion method, molten polymer resin is blown into a continuous bubble, which is then flattened into a tube, and then cut or sealed at desired intervals along the length of the tube. During the blowing of the film, the film is typically elongated in both the machine (or manufacturing) and transverse directions. This elongation is important because it changes the mechanical properties of the film. In particular, if the film tends to be elongated more in the machine direction, hereinafter referred to as the film orientation direction, than the transverse direction, this creates asymmetrical mechanical properties, with the film having higher tensile properties and lower tear properties in the machine direction. In practice this means that the bag is easier to tear in the machine direction.

In the cast extrusion method, molten polymer is extruded into a film via a die. Only the film orientation direction of the film created in this manner is elongated, which tends to lead to greater asymmetry of tensile and tear properties than seen with the blown film method.

MAP bags have been used as liners for rigid containers for fresh fruit and vegetable packaging for more than ten years. They have been well accepted in the market place.

Retailers, receivers and other stakeholders in the fresh produce supply chain, often conduct various operations such quality control, ripening, sorting and repacking procedures which require bags to be opened easily and safely. Significant costs are associated in opening MAP bags, particularly in countries where labour costs are high. Retailers now are regularly using rigid containers in which fresh fruit and vegetables are supplied as the display units for sale of the contained produce. As a result, retailers require the top surfaces of MAP liners positioned in the rigid containers to be removed from the rigid containers just prior to displaying the produce. This has created a known problem with the existing art in that it can be difficult to open the bags and/or to remove the top surface of the bags prior to displaying the produce by the retailers.

An obvious solution of tearing out the top surface of a bag is problematic because of the difficulties making straight tear lines around virtually right-angle corners and across loose creases in the bag caused by gathering the neck of the bag to the centre of the top surface for sealing.

Due to the size of the bags, it is often not possible to easily reach the inside of all of a bag when tearing the bag. Hence, to tear out the top surface of a bag means propagating tears along two separate sides of the bag, which can be separated by up to 30 cm or more. Up to now this has been proven to be quite difficult to achieve in practice.

International patent application PCT/AU2007/000049 (WO 2007/082347) in the name of the applicant discloses a solution to this problem. The entirety of International application PCT/AU2007/000049 is incorporated herein by reference. The solution involves forming a polymer bag out of a polymer material that is designed to tear with a controlled tear strength in the film orientation direction of the bag (hereafter the ‘TearFlex’ liner, which is the trade mark used by the applicant for this liner). The tear strength is reduced to a level that makes it easy for a person opening the bag to tear the bag. More particularly, a ‘TearFlex’ liner is a bag that is formed from a film of the polymer material with the film orientation direction of the film extending across the bag from side to side, i.e. parallel to an opening of the bag. The sides of the Tearflex liner are formed as heat seals and with skirts that are outboard of the heat seals. Notches are added to these skirts in locations on the sides of the bag at which it is likely that the bags would be opened. This combination of features means that the Tearflex liners, after being filled with products via openings in the liners and then closed, can be easily and controllably opened by tearing the bags at the notches in the side skirts. The tear in each bag travels through the heat sealed area on that side of the bag and continues in a controlled and easy manner across the bag and through the heat seal on the other side of the bag and forms an opening of the bag.

Alternatives to the Tearflex liner approach to providing bags that can be opened in a way that makes the bags suitable for displaying products in the bags in retail outlets include the following options.
Opening a conventional bag and emptying all of the products from the bag into a rigid container. This requires additional labour, and the extra handling can damage the fruit and vegetables.
Cutting or tearing a conventional bag. This can involve the use of knives, which adds a safety risk. Without a knife the bags can be difficult to tear, and the inevitable uneven tear lines of the bag may not be what the retailer desires, which may lower the attractiveness of the displayed produce.

As a result of using the TearFlex liner, the applicant has become aware of some entirely unexpected difficulties.

One difficulty arises from the practice of delivering as-manufactured TearFlex liners to customers of the bag in a folded flat state, with the result that the liners have to be opened by the customers before filling the liner with product.

The applicant has found that when the TearFlex liners were opened in a normal way, which typically involves packing staff ‘fluffing’ the liners (i.e. opening the liners by shaking the liners open), the liners tended to tear as the liners were opened. Careful investigation of this phenomenon showed that:
Sometimes these tears were easily visible to the naked eye, while at other times the tears were only as little as few millimetres long, which can be hard to observe.
However, even a hard to observe tear can still greatly increase the gas permeability of the bag. Since these bags have been carefully engineered for a controlled gas permeability to give desired MAP properties, a significant increase in the gas permeability can effectively ruin the intended MAP functionality of the bag.

An investigation of the uncontrolled tearing of the Tearflex bag showed that:
The liners were tearing in a film orientation direction of the polymer material, i.e. across the width of the bag from one side to the other side of the bag. This was not surprising as the liners were engineered to have a reduced tearing resistance in the film orientation, i.e. manufacturing direction.
The tears appeared to start where the Tearflex liners had been manufactured by being pierced by hot needles as described above.

From these observations the applicant has hypothesised that the uncontrolled tearing is caused by a combination of the following factors:
The tearing started when the Tearflex liners were pulled open at positions in the liners which had been pierced. This observation leads to a possible conclusion that an unintended consequence of using hot needles to pierce the bags is that the hot needles can lead to minor welding of the two adjacent layers of the liners. This property of unintended welding together of adjacent liners in folded flat layers is referred to hereinafter as ‘stiction’.
The stiction between adjacent layers of liners is usually weak and easily overcome during the normal opening of the liners. However, since the TearFlex liners have reduced tear resistance in the film orientation direction of the liner material, the stiction between adjacent layers of the liners may be stronger than the tear resistance in the film orientation direction and the un-intended tearing may result.

Not surprisingly, the applicant found that this problem could be reduced by opening the bags carefully. However this could slow down the utilization of the liners in the packing houses, and was not popular with customers, and is not a viable option on this basis.

Another possible solution is to perforate the liner material before being formed into a liner. However this requires a highly modified manufacturing process and is not a viable option on the basis of being too expensive.

### BRIEF SUMMARY OF THE INVENTION

The present invention provides an easy open MAP bag for bulk produce that does not have the difficulties discussed above or substantially alleviates at least some of the difficulties.

The bag of the present invention is the result of a combination of the following features:
The liners are manufactured as described in or along the lines described in the TearFlex International patent application PCT/AU2007/000049.
The manufactured liners are pierced to achieve MAP functionality using piercing methods that are selected to reduce the stiction of the folded liners significantly below the tear strength of the liners in the film orientation direction of the liners.

In broad terms, the present invention provides a method of manufacturing a bag from a polymer film. The method comprises:

(a) forming a bag with a front wall, a back wall, a bottom wall, opposed sides defined by heat seals of the front and back walls, skirts extending outwardly from the heat seals and an opening allowing access to the interior of the bag, and

(b) piercing the bag and forming micro-perforations to achieve MAP functionality using piercing methods that are selected to reduce the stiction of the film in the front and back walls significantly below the tear strength of the film in the film orientation direction.

In more specific terms, according to the present invention there is provided a method of manufacturing a bag, such as a liner for storing perishable products including fresh fruit and vegetables, that comprises the steps of (a) folding a sheet of a polymer film having a film orientation direction in a lengthwise extending direction of the film around a lengthwise extending fold line and forming a folded sheet having an upper layer of the film positioned on a lower film layer, (b) heat sealing together two sections of the upper and lower layers of the folded sheet and forming two parallel, spaced apart heat seals extending transversely, preferably perpendicular, to the film orientation direction of the film, (c) cutting the folded sheet parallel to and outwardly of the heat seals and thereby forming a bag with a bottom wall, opposed sides and skirts extending outwardly from the heat seals and an opening, and (d) piercing the bag and forming micro-perforations to achieve MAP functionality using piercing methods that are selected to reduce the stiction of the layers of film significantly below the tear strength of the film in the film orientation direction.

The term “film orientation direction” is understood herein to mean that the molecules of the polymer of a polymer film from which the bag is formed are not completely randomly arranged and are preferentially oriented to a certain extent in a given direction. The orientation may be the result of processing a molten polymer in such a way, for example by extrusion, that orients the polymer in a given direction. Alternatively, or in addition, the orientation may be the result of processing of a film that has been formed.

The piercing step may be carried out in line, i.e. successively, with the other steps described above.

Alternatively, the piercing step may be carried out as a separate step to the other steps.

In one embodiment the step of piercing the bag comprises a laser piercing step. Laser piercing has an advantage that the material in the holes is vaporised by the laser and the vapour is extracted away from the liners. As the vaporisation occurs progressively through the depth of the micro-perforations, all excess material is extracted away from the liners as the micro-perforations are formed.

In another, but not the only other, embodiment the step of piercing the bag comprises piercing the bags using the ‘Perftech’ method described in International patent application PCT/AU01/01503 (published under number WO02/40250) in the name of the applicant. This method comprises piercing the bag using a roll, such as a modified gravure type roll, containing arrays of micro-perforation pins. Preferably the method comprises feeding the bag into a nip defined by the modified gravure roll and a smooth backing roll, such as a rubber backing roll. The entirety of International application PCT/AU01/01503 and corresponding U.S. published application US2004/0125631 are incorporated herein by reference.

Preferably the polymer film has an Elmendorf Tear Strength (ASTM D1922) in the range of 0.05 to 0.50N in the film orientation direction.

Preferably the method includes forming at least one tear initiation notch in at least one of the skirts.

The folded sheet of the polymer film may be made by any suitable method step or steps.

The polymer film may be formed by any suitable method.

For example, the polymer film tube may be a blown film.

According to the present invention there is provided a bag made in accordance with the above-described method.

The importance of the correct selection of the piercing process to make the bags is shown in the following experiments.

The data collected to date is based on the use of an Instron tensiometer running at 2500 mm per minute to simulate a liner being opened or being torn. Whilst this rate is significantly slower than the actual action of opening or tearing a liner, it is the highest available speed with the instrument available to the applicant, and is considered to provide a reasonable simulation of the liner opening process.

The measurements taken were the force required to either peel apart two adjacent layers of film at the point of a micro-perforation, or the force to tear the film from an initial cut. The tearing action was created by taking a strip of film, making a length-wise cut down the centre for 15% of the strip length, then positioning the left side of the strip beside the cut in the lower jaw and the right side of the strip beside the cut in the upper jaw, with these half width strips offset to the appropriate sides of the jaws. Results measured are in Newtons.

### Tear Strength of Film

All films in this table had a nominal thickness of 30 um.

| | Force required to propagate | |
|---|---|---|
| Formulation | tear (20 replicates) | |
| Non TearFlex polyethylene, | 2.1 to 5 | N |
| Manufacturing direction (MD) | | |
| Polyethylene, tranverse to | 2.4 to 7 | N |
| the manufacturing direction | | |
| (TD) | | |
| TearFlex, as disclosed in | 0.2 to 0.7 | N |
| PCT/AU2007/000049 | | |

### Force Required to Peel Apart Adjacent Layers at Micro-Perforation

All films in this table had a nominal thickness of 30 um.

| | Force required to separate |
|---|---|
| Formulation | two layers of film, |
| Hot needle perforations | |
| (i) Polyethylene | 1.0-2.0 N (16 perforations |
| | tested) |
| (ii) TearFlex, as disclosed | 0.8-2.3 N (16 perforations |
| in PCT/AU2007/000049 | tested) |
| Laser perforations | |
| (i) Polyethylene, 200 um | 0.07-0.25 N (5 strips of |
| diameter perforations | perforations tested) |
| (ii) Nylon, 100 um diameter | 0.05-0.23 N (5 strips |
| perforations | of perforations tested) |
| (iii) TearFlex, 120 um | 0.17-0.31 N (with force |
| diameter perforations | required to separate the |
| | slightly blocked film layers |
| | being 0.10-0.15 N |
| Perftech perforations, | <0.05 N, (16 perforations) |
| nylon/polyethylene copolymer | |

The above data shows that a force of 0.8 N to 2.3 N was required to separate 2 layers of film formed with hot needle perforations. This is largely independent of the film formulation used. This is not a problem with the polyethylene film used in MAP liners without the tear functionality, as tear propagation requires over 3 N. However, TearFlex bags will propagate tears across the liner at 0.3 N to 0.5 N, which is less than the force to break the welds adjacent to the hot needle micro-perforations. Hence, it is likely that breaking hot needle generated welds can also propagate a tear from the micro-perforations.

On the other hand, a force of just 0.05 N to 0.31 N was required to separate 2 layers of film with laser generated micro-perforations. This appears to be largely independent of the film formulation used and of the diameter of the perforations. In this test, some film strips contained several micro-perforations every 1 mm continuously. The peeling action proceeded along the line of micro-perforations, with most of the micro-perforations separating at forces of 0.10 N to 0.16 N. With the TearFlex sample, perforations were separated at intervals of 50 mm to allow individual perforations to be separated.

An even lower force of less than 0.05N was required to separate the two layers of the liner perforated using the Perftech technology.

### BRIEF DESCRIPTION OF THE DRAWINGS

The present invention is described further by way of example with reference to the following drawings of which:

FIG. 1 is a plan view of one embodiment of the bag in accordance with the present invention in an as-manufactured configuration;

FIG. 2 shows a detail of the side of the bag shown in FIG. 1;

FIG. 3 shows the bag after it has been opened; and

FIG. 4 shows the bag in use inside a rigid container, such as a cardboard box, ready for filling with produce.

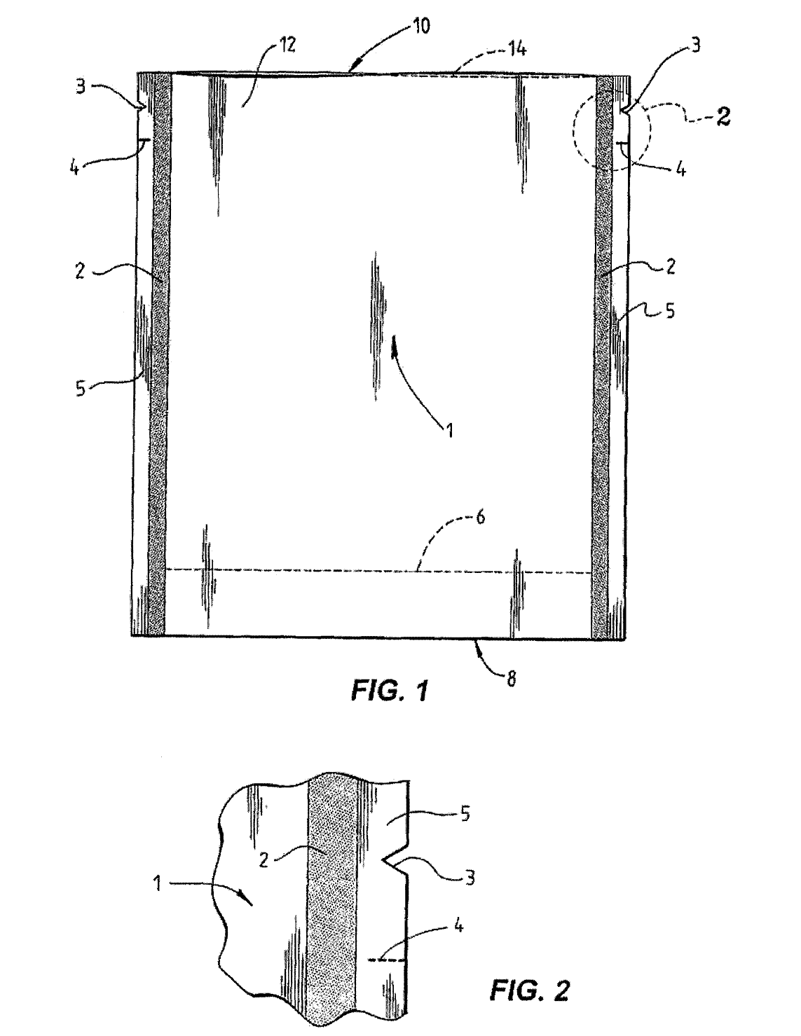

### DETAILED DESCRIPTION OF THE INVENTION

The bag 1 shown in the Figures is made from a polymer film and comprises (a) a front wall 12, (b) a back wall (not shown), (c) a closed bottom 8, (d) an opening 10, and (e) opposite sides that are defined by heat seals 2 and side skirts 5 that extend outwardly from the heat seals 2.

The bag 1 also includes a gusset 6 in the bottom 8 of the bag to help the bag expand its volume.

The bag 1 also includes a tear initiation notch 3 in the skirt 5 on each side of the bag 1.

The bag 1 also includes a plurality of micro-perforations (not shown) in the polymer film to achieve MAP functionality.

The bag 1 is manufactured as described in TearFlex International patent application PCT/AU2007/000049.

In one embodiment of the present invention, the bag 1 is pierced to form the plurality of micro-perforations using a laser piercing step that vaporises material from the bag to form the micro-perforations, with the vapour being extracted away from the bag and thereby removing the material from the bag.

In another embodiment of the present invention, the bag 1 is pierced to form the plurality of micro-perforations using the ‘Perftech’ method described in International patent application PCT/AU01/01503 in the name of the applicant.

FIG. 2 shows a detail of the right side of the bag. The Figure shows the body of the bag 1, the heat seal 2, the side skirt 5, the v-notch tear initiator 3, and a line notch tear initiator 4.

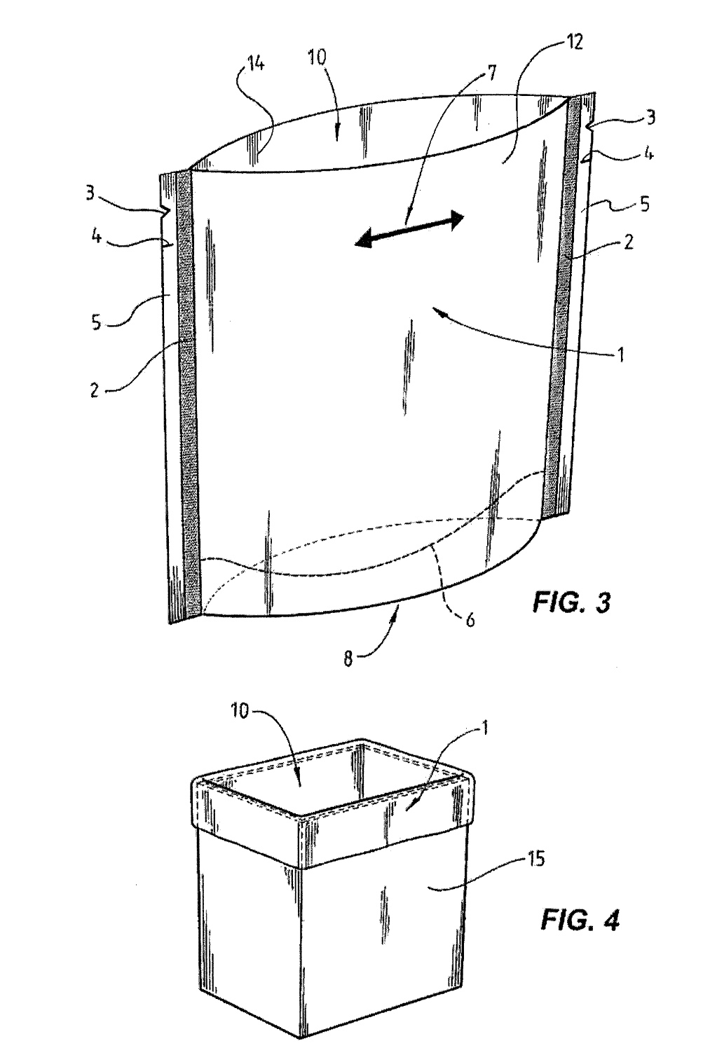

FIG. 3 shows the bag 1 in an expanded form, with an arrow 7 showing the main orientation in the polymer of the bag. The bag is normally closed with either a simple cable tie after filling, although it is possible to heat seal the top of the bag or use other closing means such as clips, rubber bands or yarns or other devices.

FIG. 4 shows the open bag inside a rigid container ready for filling with produce.

Many modifications may be made to the embodiment of the bag described above in relation to the drawings without departing from the spirit and scope of the present invention.

1. A method of manufacturing a bag, such as a liner for storing perishable products including fresh fruit and vegetables, that comprises the steps of
(a) folding a sheet of a polymer film having a film orientation direction in a lengthwise extending direction of the film around a lengthwise extending fold line and forming a folded sheet having an upper layer of the film positioned on a lower film layer,
(b) heat sealing together two sections of the upper and lower layers of the folded sheet and forming two parallel, spaced apart heat seals extending transversely, preferably perpendicular, to the film orientation direction of the film,
(c) cutting the folded sheet parallel to and outwardly of the heat seals and thereby forming a bag with a bottom wall and opposed sides and skirts extending outwardly from the heat seals and an opening, and
(d) piercing the bag and forming micro-perforations to achieve MAP functionality using piercing methods that are selected to reduce the stiction of the layers of film significantly below the tear strength of the film in the film orientation direction.

2. The method defined in claim 1 comprises carrying out the piercing step in line, i.e. successively, with the other steps defined in claim 1.

3. The method defined in claim 1 comprises carrying out the piercing step as a separate step to the other steps defined in claim 1.

4. The method defined in claim 1 wherein the piercing step comprises using a laser to pierce the bag and vaporising material in the holes in the bag

5. The method defined in claim 4 comprises extracting the vaporised material away from the bag.

6. The method defined in claim 1 wherein the step of piercing the bag comprises piercing the bag using the ‘Perftech’ method described in International patent application PCT/AU01/01503 (published under number WO02/40250) in the name of the applicant.

7. The method defined in claim 6 comprises piercing the bag by passing the bag through a nip defined by a roll containing arrays of micro-perforation pins and a smooth backing roll.

8. The method defined in claim 1 wherein the polymer film has an Elmendorf Tear Strength (ASTM D1922) in the range of 0.05 to 0.50N in the film orientation direction.

9. A bag made in accordance with the method defined in claim 1.

10. A method of manufacturing a bag from a polymer film comprises (a) forming a bag with a front wall, a back wall, a bottom wall, opposed sides defined by heat seals of the front and back walls, skirts extending outwardly from the heat seals and an opening allowing access to the interior of the bag, and (b) piercing the bag and forming micro-perforations to achieve MAP functionality using piercing methods that are selected to reduce the stiction of the film in the front and back walls significantly below the tear strength of the film in the film orientation direction.
